(19) United States
(12) Patent Application Publication
(10) Pub. No.: US 2010/0006257 A1
(43) Pub. Date: Jan. 14, 2010

(54) Lightweight Rooftop Air Conditioning and/or Heating System

(76) Inventor: Wolfgang Schütz, Edermunde (DE)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 12/443,929

(22) PCT Filed: Oct. 5, 2007
(86) PCT No.: PCT/DE07/01782

§ 371 Date: Apr. 1, 2009

(30) Foreign Application Priority Data
Oct. 6, 2006 (DE) 10 2006 047 369.8

(51) Int. Cl. B60H 1/00

(52) U.S. Cl. 165/61

(57) ABSTRACT

The invention relates to an air conditioning and/or beating system (1) for vehicles having a housing (3) which is designed to be positioned partially in or entirely on a vehicle roof (5) and comprises at least one component (7) of the air conditioning and/or heating systems (1), wherein the housing (3) is composed at least partially of foamed plastic, and at least one area of the surface of the housing is coated with a material which is resistant to ultraviolet radiation, and the housing (3) or housing part which is composed of foamed plastic contains at least a part of at least one insert which is designed to contribute to mounting the housing (3) on a vehicle roof (5) or in a recess in the vehicle roof (5).

### TECHNICAL FIELD

The invention relates to an air conditioning and/or heating system according to the preamble of claim 1 having a housing which is designed to be positioned partially in or entirely on a vehicle roof, which encloses at least one structural component of the air conditioning and/or heating system. Such air conditioning and/or heating systems are used in particular with larger air conditioning and/or heating systems, such as for example for omnibuses or rail vehicles.

When the housing is positioned on the roof so that it is located partially in the passenger roof area, the recess provided for the housing in the passenger roof area is partially integrated, so that only the upper part of the housing is extended over the passenger roof area.

One structural element of an air conditioning and/or heating system is a functional part of such a system such as for example a heat exchange battery, a blower, a condenser, a compressor or an expansion device for expansion of the cooling medium.

A heat exchange battery can consist of an evaporator, a heater heat exchanger, or of both of these elements.

### PRIOR ART

In an air conditioning system, a compressor compresses a gaseous cooling medium and transports the medium through a supply line to a condenser. The condenser, which serves as a heat exchanger, is cooled by the air which is drawn in through an air inlet and carried away through an air outlet. The cooling medium, which was in gaseous form and which is subjected to a high pressure, is thus liquefied. The cooling medium, which is at this time in a fluid form, is supplied through a supply line to an expansion device such as for example a throttle, whereby the pressure on the cooling medium can be relaxed. Due to the relaxation, the cooling medium transitions into the gaseous state and extracts in this manner ambient heat. This extraction of heat affects the ambient air by means of an evaporator which serves as a heat exchanger in the area of the vehicle to be cooled. The ambient air is in this case drawn in by means of a blower through an inlet opening, supplied to the evaporator, cooled and then supplied through the corresponding openings provided in the area to be cooled inside the vehicle. Therefore, since the temperature of the cooling medium is increased during the cooling of the ambient air, the cooling medium is warmed again. It is then supplied again to the compressor where it is compressed again. The cooling circulation process is thus begun again.

Heat exchangers of a known type are employed in a heating system which is used in a vehicle. This system warms by means of a fan air which is supplied through a heater heat exchanger and then directed through the openings inside the vehicle.

In a combined air conditioning and heating system for a vehicle, a heat exchange battery comprises for example a heater heat exchanger and an evaporator.

Known systems include air conditioning and/or heating system provided with a housing on the vehicle roof made of a steel plate or a stable injection molding plastic which is used at least in one part of the structural element of the air conditioning and/or heating system. However, materials such as steel plates or stable injection molding plastic materials which are used these days for such rooftop housing units are quite expensive to produce and not particularly light. Nevertheless, reduced weight is a particularly important requirement for structures installed on or above the roof of a vehicle as it is necessary to prevent tilting or even overturning of the vehicles when the center of gravity of the vehicle is located at a high level due to the weight of the roof.

In the German Laid-Open Patent Application DE 199 13 776 A1 is disclosed an air conditioning system, preferably for rail vehicles, wherein the housing, which is referred to in this document as an instrument shell, is integrated in the roof of the vehicle. The instrument shell disclosed therein is made of materials which are customarily used for rooftop air conditioning systems such as metal. The document describes for example welding to the construction of a railroad wagon. Also US Patent Document U.S. Pat. No. 5,632,330 describes an air conditioning system provided with a rooftop housing for vehicles manufactured from customarily used materials such as for example metal or a stable injection molding plastic material.

German Laid-Open Patent Application DE 198 02 055 A1 discloses a heating or air conditioning system of a vehicle wherein at least two parts of the housing of the unit are manufactured from foam having particles of plastic material. However, both patent documents describe air conditioning units or air conditioning apparatuses whose housing is made of a light and inexpensive material, not rooftop air conditioning and/or rooftop air conditioning units, so that in particular the aspects relating to deterioration of the materials which is caused by solar radiation and a stable assembly on the roof of the vehicle are not taken into consideration in this document. Also, since the construction for attachment to the roof described in German Patent DE 101 50 011 B4, wherein a special metal insert which is attachable to the roof of the vehicle is partially integrated in a frame made of foamed plastic, and the frame is used to enclose a casing cover, for example for sunroofs, is designed for stable attachment of a housing to the roof of a vehicle in a rooftop air conditioning and/or rooftop heating unit, this fact alone means that DE 101 50 011 B4 is also not suitable for a similar purpose due to clearly higher requirements on stability.

The objective of the invention is therefore to provide an air conditioning and/or heating system for a vehicle, which is improved with respect to reduced weight and reduced manufacturing costs, while taking into account the aspect of the durability of the housing material and its attachment to the roof of a vehicle for vehicles provided with a housing designed to be positioned on the roof of a vehicle partially or entirely, which encloses at least one structural element of the air conditioning and/or heating system.

### SUMMARY OF THE INVENTION

The objective is achieved with the air conditioning and/or heating system for vehicles having a housing which is designed for roof positioning so to be positioned partially in or entirely on the roof of a vehicle, and the housing encloses at least one structural element of the air conditioning and/or heating system, wherein the housing is made at least partially of a foamed plastic, and at least one area of the surface of the housing is coated with a material resistant to ultraviolet radiation, and the housing or the housing part which is made of foamed plastic contains at least a part of at least one insert which is designed to contribute to mounting of the housing on the roof of a vehicle or in a recess on the roof of the vehicle.

Since the housing of the air conditioning and/or heating system, which is configured so that it can be partially or completely positioned on a rooftop, is made at least partially of a foamed plastic, it can be manufactured inexpensively and in a simple manner and it is also extra lightweight. Therefore, the center of gravity of a vehicle provided with the air conditioning and/or heating system according to the invention is advantageously located relatively low, wherein in particular the risk of swiveling or even the risk that that vehicle will overturn is relatively low.

The housing contains at least one part of at least one insert. An insert is in this case an element which is connected with the housing and which is made of a material that is more stable than foamed plastic. The connection of the insert with the housing can be realized for example with foam cladding of the foamed plastic. Therefore, since at least one of the inserts is designed for attachment of the housing to the rooftop of a vehicle or to correspond to attachment to a recess of the rooftop, the housing can be mounted on the rooftop securely and with sufficient strength. Above all, the particular characteristics of the material used for the fixing of the insert do not need to be taken into consideration and customary fixing can be employed. Since at least one area of the surface of the housing of the air conditioning and/or heating system according to the invention is coated with a material which is resistant to ultraviolet radiation, deterioration such as for example weathering due to the impact of sun rays on the rooftop of the housing which is made at least partially of foamed plastic is prevented.

Advantageous embodiments, modifications and improvements of the object of the invention are described in subordinated claims.

The stability of the housing is increased with the inserts, which is above all an improvement of rooftop housings also due to safety reasons. In addition, the inserts can also assume mounting support functions,

in particular when the foamed plastic of the housing is too instable or not suitable for a sufficient fixing thereof. The mounting support function of an insert, such as providing support for the mounting of a structural element of an air conditioning and/or heating system, are advantageous. In particular with a compressor and a blower, a corresponding shape of the foamed plastic of the housing is often per se not sufficient.

All materials are suitable for the inserts, while metal or a stable plastic material is particularly suitable. These materials can be formed into the desired shape and they have a stabilizing effect. An insert can be manufactured from metal in the form of a grid.

It is advantageous for the stability of the housing when at least one of the inserts is configured to contribute to the stabilization of the housing.

According to an advantageous development of the present invention, the foamed plastic of the housing provides additional mounting support for at least one structural element of the air conditioning and/or heating system. The structural elements can be thus fixed without an additional mounting frame, which above all enables savings with respect to the weight, costs, and expenditures.

Expanded polypropylene (EPP) is particularly suitable for the foamed plastic to be used for the housing due to its suitable material characteristics.

An advantageous configuration of the present invention is an air conditioning and/or heating system, wherein the housing according to the invention serves as an enclosure for at least one blower of the air conditioning and/or heating system. The positioning of the blower on the roof of a vehicle is in particular advantageous for supplying fresh air.

The air conditioning and/or heating system according to the invention are particularly suitable for omnibuses or rail vehicles due to the size of the required equipment, which results in increased relevancy of the reduced weight when compared to prior art.

### BRIEF DESCRIPTION OF FIGURES

Embodiments of the invention will now be explained based on the figures. The figures show the following:

FIG. 1 a schematic drawing of an embodiment of an air conditioning and/or heating system according to the invention provided with a housing on the roof of an omnibus;

FIG. 2 a schematic drawing of an embodiment of one part of a housing having an insert for the air conditioning and/or heating system according to the invention;

FIG. 3 a schematic drawing of a section of another embodiment of a housing having an inserts which is also used for fixing of the housing on the roof of a vehicle; in an air conditioning and/or heating system according to the invention;

FIG. 4 a schematic drawing of another embodiment of a housing according to the invention having an insert which also serves for the fixing of the housing on the roof of a vehicle in an air conditioning and/or heating system according to the invention;

FIG. 5 a schematic drawing of an embodiment of a housing equipped with a cover part and with an evaporator case in an air conditioning and/or heating system according to the invention;

FIG. 6 a schematic drawing of an embodiment of a segment of a housing according to the invention of an air conditioning and/or heating system according to the invention; and

FIG. 7 a schematic drawing of another embodiment of an air conditioning and/or heating system according to the invention having a housing on the roof of a vehicle.

### DETAILED DESCRIPTION OF THE INVENTION

The same reference symbols are used to designate components having the same or similar function in all the figures. All the reference symbols are to be understood schematically.

The scale of the illustrations is not based on real dimension so as to provide a clear representation.

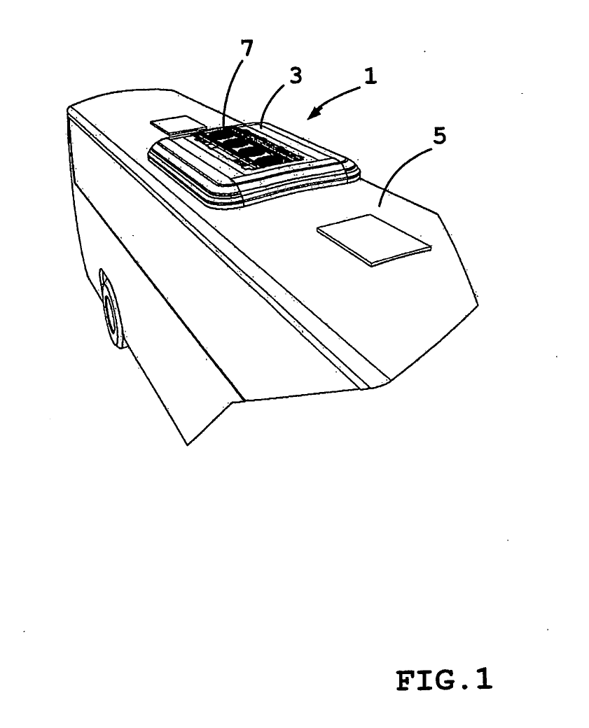

FIG. 1 shows a schematic drawing of an embodiment of an air conditioning and/or heating system 1 according to the invention having a housing 3 on the roof 5 of an omnibus. The housing 3, which is made from a foamed plastic, for example from expanded polypropylene (EPP), encloses as structural elements the air conditioning and/or heating system 1 having at least a heat exchange battery, which is configured as an evaporator provided with a heater heat exchanger, a blower and a condenser unit 7. The structural elements of the air conditioning and/or heating system 1, which are not located in the housing 3, can be accommodated for example inside the vehicle. The surface of the housing 3 is coated with a material resistant to ultraviolet radiation, such as for example a thermoplast (ASA).

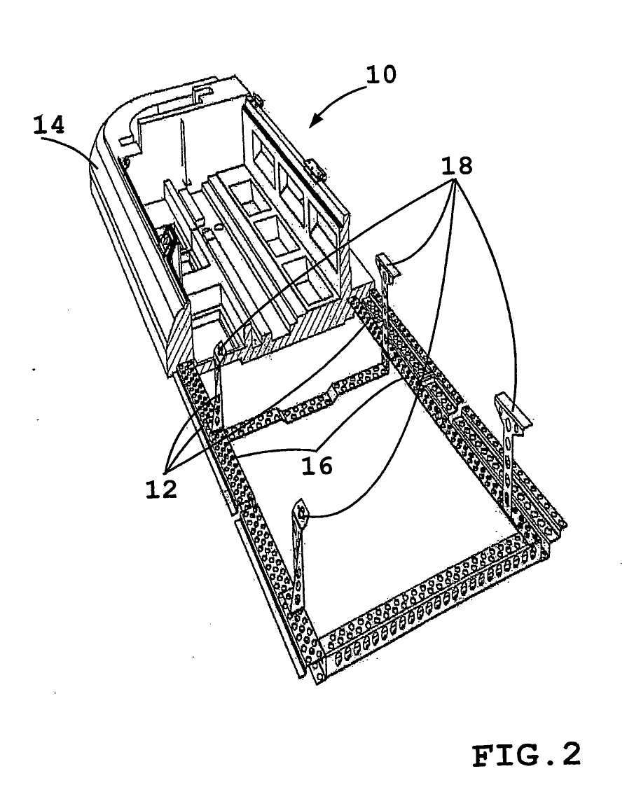

FIG. 2 shows a schematic drawing of an embodiment of part 10 of a housing provided with inserts 12 for an air conditioning and/or heating system according to the invention. This housing part 10, configured as an evaporator case, is made of EPP 14 which is used as foamed plastic, contains a metallic insert 12. Without limiting the general characteristics, for example aluminum can be used for this purpose. However, the inserts can be also made from other suitable materials, such as for example a stable plastic material.

The inserts 12 are in this example configured so that they are equipped with two lateral longitudinal rails 16 having supporting struts 18, which are mounted vertically at a predetermined interval between them and which serve to reinforce a part of the cover, not shown in the figure.

Both lateral longitudinal rails 16 and the supporting struts 18 of the insert 12 are foamed in the longitudinal faces of the evaporator case 10. This is illustrated by the striped section deployed diagonally in the foamed plastic 14 of the evaporator case 10 as indicated in FIG. 2. The inserts 12 are provided with a perforated structure. The areas of the inserts 12 which are linked into the housing are provided with holes in the insert 12 which are foamed using EPP or another suitable foamed plastic. The inserts 12 are thus particularly firmly connected to the housing. In addition to the perforated structure, other recessed forms of the insert 12 are also conceivable. For example, the insert 12 can be also provided with a grid structure.

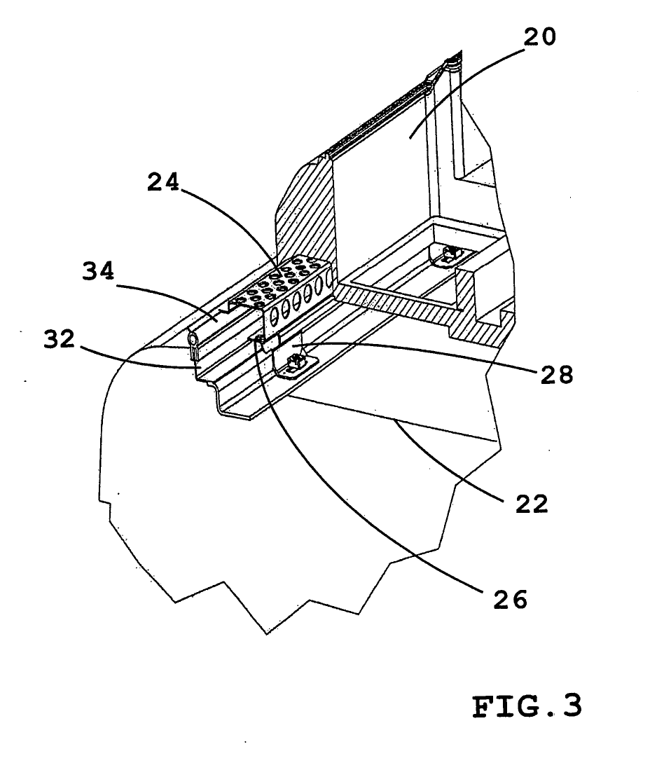

FIG. 3 shows a schematic drawing of a section of another embodiment of the housing 20 of an air conditioning and/or heating system having a housing 20 provided with inserts 24 used for fixing to a vehicle roof 22. A metallic insert 24 is incorporated in the foamed body in the lower region with a perforated, rail-like shape on one longitudinal side of the housing 20 which is made of EPP. This is indicated in the illustrations by a striped cross-section in the foamed plastic of the housing 20.

The insert 24 is provided on its inner bottom side 28 with holes enabling to screw on U-shaped retaining clips 30. This bottom side 26 is directly adjacent to the bottom surface of the housing 20 of the air conditioning and/or heating system. The retaining clip 28, which is screwed onto the bottom side of the insert 24, is screwed onto a rooftop ledge 20 which is fixed to the roof 22 of the vehicle. The fixing of the housing 20 of the air conditioning and/or heating system to the vehicle roof 22 is thus realized with the screwed connection. Depending on the type of the fixing system provided on the rooftop 22, and depending on the type of the vehicle, another suitable connecting element can be also attached to the insert 24 instead of a holding clip 28.

A rail 32 having an L-shaped profile is attached to a roof assembly ledge 30 outside of the longitudinal side, which is equipped in its upper edge with a sealing ledge 34 made of sealing rubber or another sealing material. The housing 20 of the air conditioning and/or heating system is deployed on this outer sealing ledge so that it is hermetically sealed as well as waterproof with respect to the vehicle roof 22.

In order to stabilize the regions of the housing 20 supported therein, the insert 24 which is incorporated in the foamed body is extended with its outer side over this area.

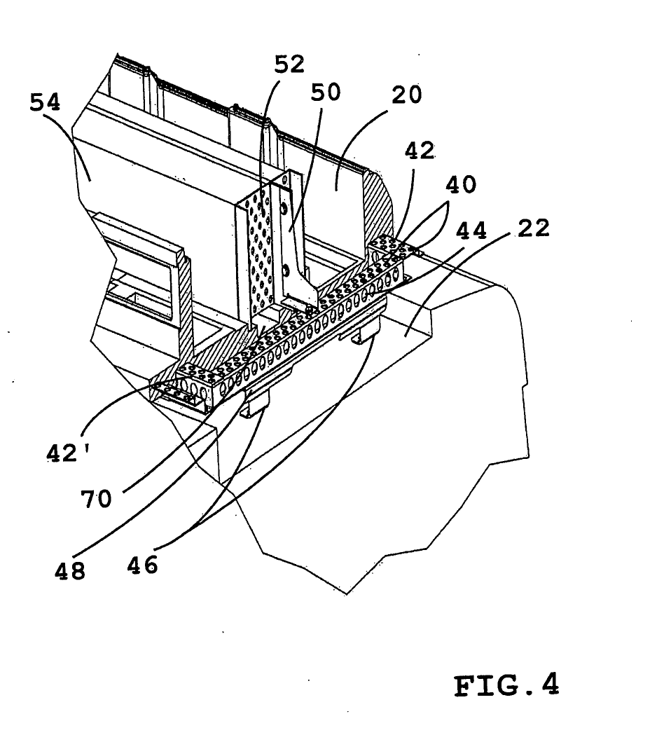

FIG. 4 shows a schematic drawing of a section of yet another embodiment of the housing 20 according to the invention having inserts 40 which are also used for fixing on the rooftop 22 of an air conditioning and/or heating system according to the invention. The inserts 40 essentially comprise longitudinal rails 42, 42′, incorporated in the foamed plastic of the housing 20, and a cross strut 44. The cross strut is shown as a striped section laid open diagonally in the foamed plastic of the housing 20. The inserts 40 are provided with a perforated structure, wherein the holes on the upper face and on the lower face of the insert 40 are designed to be suitable for a screwed connection.

The lower face of the cross strut 44 is located directly on the lower surface of the housing 20 of the air conditioning and/or heating system. A connection ledge 44 provided with retaining clips 46 is screwed onto this lower face of the cross strut 44 to fix to the lower face with the retaining clips 46 to the roof 22 of a vehicle. Fixing of the housing 20 of the air conditioning or/and heating system to the rooftop of the vehicle is thus enabled with this screwed connection.

Further, an L-bracket 50 having a rectangular metal fixing plate 52, which can be made for example from a metal such as aluminum, is screwed approximately in the center of the cross strut 44 onto the inner upper surface of the housing 20. The metal fixing plate 52 is thus deployed at right angle to the cross strut 44 of the insert 40, and it is provided with a perforated structure, which is used on the one hand in order to reduce the weight, and on the other hand also for fixing of the structure of the structural elements of the air conditioning and/or heating system. A heat exchange battery 54, which is inserted into the housing 20, is fixed to the metal fixing plate 52. The insert 40 thus also serves to support the structural elements of the air conditioning and/or heating system, wherein the form of the support does not have to be limited to the form illustrated in the embodiment.

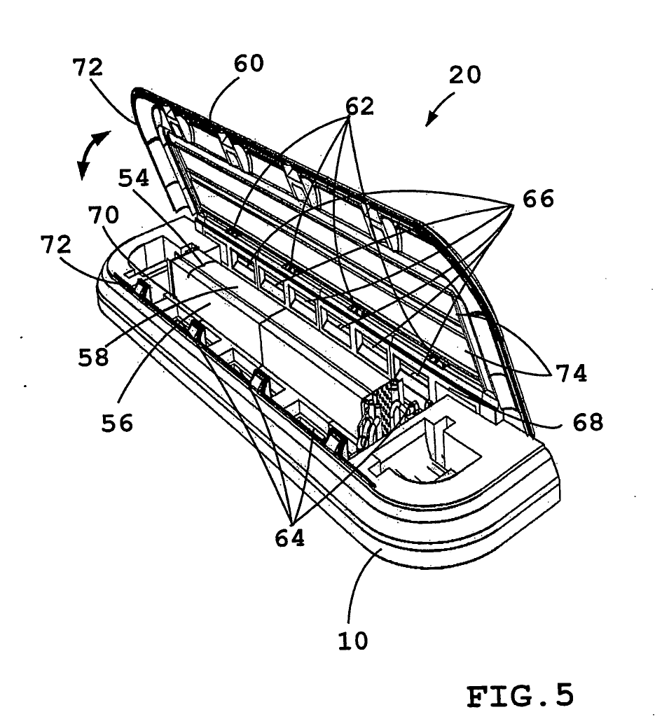

FIG. 5 shows a schematic illustration of an embodiment of a housing 20 having a cover part 60 and an evaporator case 10, which contains two contiguous heat exchange batteries 54 of the air conditioning and/or heating system according to the invention. The cover part 60 is made of EPP and, without being limited by this, it is fixed with four hinges 62 on the upper longitudinal edge of the rear wall 68 of the evaporator case 10, which is also made of EPP, so that it can be closed shut. The cover part 60 is equipped with side edges which are curved in the downward direction and it is provided with a sealing rubber 72 component along its lower edge, so that a hermetic and waterproof seal can be created when the cover part 60 is closed on the evaporator case 10, which is also provided for this purpose with a corresponding sealing rubber element 72 on its upper edge. Other sealing materials known in the art can be also employed. Further, a locking connection which provides a hermetic and waterproof seal between the evaporator casing 10 and the cover part 60 is also conceivable without a sealing material.

Furthermore, the cover part 60 is equipped on its inner side with rectangular recesses 74 created in the foamed plastic which in the closed state provide additional support for the heat exchange batteries 54 inserted in the evaporator case 10.

Further still, the bottom of the evaporator case 10 is provided, without being limited by this, with six inner and outer rectangular openings 64 enabling to supply air to and remove air from the inner area of the vehicle, wherein the six inner openings 64 indicated in the perspective drawing in FIG. 5 are mostly covered by the heat exchange batteries 54.

Additional rectangular openings 66, for example six, are also located in the air conditioning and/or heating system in the rear wall 68 of the evaporator case 10 through which fresh air can be sucked in from outside. The foamed plastic is in the inner part of the bottom evaporator case 10 formed with a matching shape, so that the heat exchange batteries 54 can be inserted with precision. The recess 70 in the inner bottom part provides additional support for the heat exchange batteries 54. The front part 56 of the heat exchange batteries 54 is in this example a heater heat exchanger and the rear part 58 is an evaporator.

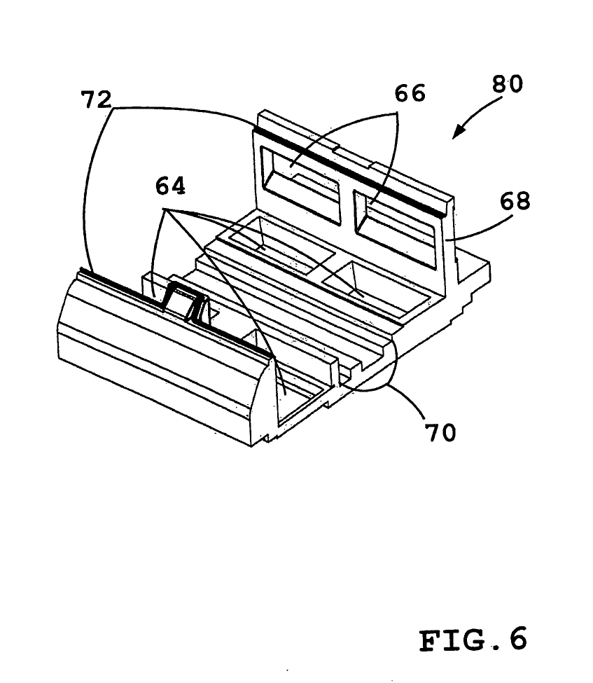

FIG. 6 shows a schematic drawing of an embodiment of segment 80 of a housing of an air conditioning and/or heating system according to the invention.

One segment of a housing can be a housing part or a housing module of a housing part.

In this case, a housing part intermediate module 80 is used as an intermediate part of one evaporator case 10 shown in FIG. 5. This intermediate module 80 is made for example of a foamed plastic, such as for instance EPP. A recess 70 for a heat exchange battery is located in the longitudinal direction in the center of the inner bottom. In addition, the evaporator case intermediate module 80 is provided in the inner and outer bottom part with two respective rectangular openings 64 enabling to supply air to and remove it from the inner area of the vehicle. Two rectangular openings 66 of the air conditioning and/or heating system which supply fresh air are also located in the rear wall 68 of the intermediate module 80.

Sealing rubber components 72 are attached on the upper edge of the housing part intermediate module 80. However, other sealing materials can be also employed, or it is also possible to create a locking hermetic and waterproof seal without a sealing material with a housing part supported in the upper part.

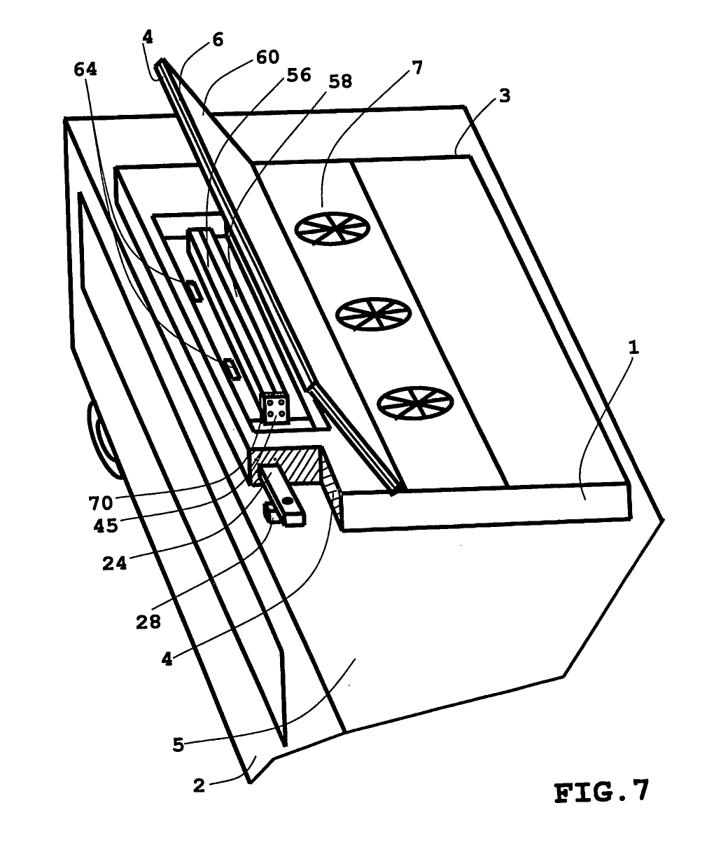

FIG. 7 shows a schematic drawing of an embodiment of the air conditioning and/or heating system 1 according to the invention having a housing 3 on a vehicle roof 5.

The heat exchange battery belonging to the system 1 comprises in this case on one of its sides a heater heat exchanger 56 and on the other side an evaporator 58. The housing 3 of the air conditioning and/or heating system 1 is fixed to the roof of a vehicle 2, such as for example a rail vehicle or an omnibus. However, not all the structural elements of the rooftop air conditioning and/or heating system 1 need to be integrated in the housing 3 on the rooftop 5. For example, the compressor can be located near the motor of the vehicle. In the example illustrated in FIG. 7, at least the blower, the heat exchange battery comprising an evaporator 58 and a heater heat exchanger 56 and the condenser 7 are located in the housing 3 on the roof 5 of the vehicle 2. The housing 3 is made primarily from a foamed plastic 4, such as for example expanded polypropylene (EPP). The surface of the housing 3 is coated with a material resisting ultraviolet radiation, such as for example thermoplast (ASA).

For example, the lower side of the cover 60 of the evaporator unit can be made of foamed material 4 and the upper side can be made from material 6 which is resistant to ultraviolet radiation. An insert, made for example of a sturdy plastic or metal, 4 is laterally incorporated in the foamed body of the foamed plastic 4. In order to make this insert 24 visible, a corresponding cutout is indicated in FIG. 7 in the upper left corner of the housing 5. The insert 24 is fixed to a connection element 28, which in turn is attached to the vehicle roof 5 so that the insert 24 contributes also to the fixing of the housing 3 to the vehicle roof 5. Further, the insert 24 also increases the stability of the housing 5. In an additional insert 45, which is partially integrated into the foamed plastic 4 of the housing 45, is attached a heat exchange battery comprising a heating heat exchanger 56 and an evaporator 58, for example with a screwed connection. Furthermore, additional support is provided for the heat exchange battery with a matching recess 70 formed in the foamed plastic 4 in the inner bottom of the housing 3, so that the foamed plastic 4 of the housing 3 contributes to fixing of these structural elements 56, 58.

In another variant, the housing is partially integrated in the vehicle roof 5, wherein at least one insert 24 contributes to the support provided for the housing 3 on the vehicle roof 5 in a manner similar to the case described above.

In addition to the evaporator unit, for example the condenser can be also integrated with the rooftop housing made of a foamed plastic in the air conditioning and/or heating system according to this invention.

Moreover, the housing for an air conditioning and/or heating system according to the invention can be configured to enclose at least one structural element of the air conditioning and/or heating system, wherein the housing is designed to be positioned partially or entirely on a rooftop, and made at least partially of a foamed plastic, so that at least one area of the surface of the housing is coated with a material resistant to ultraviolet radiation, which contains at least one insert designed so that it contributes at least partially to the fixing of the housing on a rooftop or in a recess, as well as a segment made of at least partially of a foamed plastic in such a housing for which individual protection is claimed.

1. An air conditioning and/or heating system (1) for vehicles (2) designed for rooftop positioning so as to be positioned entirely on or partially in a vehicle roof (5, 22), comprising:
at least one structural element (7, 54) of the air conditioning and/or heating system 1, the housing (3, 20) has a surface;
at least part of the housing (3, 20) is made of a foamed plastic (4);
at least one area of the surface of the housing is coated with a material (6) resistant to ultraviolet radiation; and
at least part of the housing (3, 10, 20) which is made of a foamed plastic (4) comprises at least a part of at least one insert (12, 24, 40) which is designed to contribute to the fixing of the housing (3, 20) to a vehicle roof (5, 11) or in a recess of the vehicle roof (5, 22).

2. The air conditioning and/or heating system (1) according to claim 1, wherein the at least one insert (12, 24, 40) is configured so as to contribute to the support provided by supports (50, 52) for the structural element (7, 54) of the air conditioning and/or heating system (1).

3. The air conditioning and/or heating system (1) according to claim 1, wherein the at least one insert (12, 24, 40) is made of a metal or a stable plastic.

4. The air conditioning and/or heating system (1) according to claim 1, wherein at least one of the inserts (12, 24, 40) is configured so as to contribute to the stabilizing of the housing (3, 20).

5. The air conditioning and/or heating system (1) according to claim 1, wherein the foamed plastic (4) of the housing (3, 20) is formed so that it contributes to the support provided for the structural element (7, 54) of the air conditioning and/or heating system (1).

6. The air conditioning and/or heating system (1) according to claim 1, wherein the foamed plastic (4) of the housing (3, 20) is expanded polypropylene (EPP).

7. The air conditioning and/or heating system (1) according to claim 1, wherein the housing (3, 20) is designed so as to enclose at least one blower of the air conditioning and/or heating system (1).

8. The air conditioning and/or heating system (1) according to claim 1, wherein the housing (3, 20) is designed to be positioned on a rooftop (5, 22) of an omnibus or a rail vehicle.

9. The air conditioning and/or heating system (1) according to claim 1, wherein the housing (3, 20) is designed to be partially integrated in the rooftop (5, 22) of an omnibus or a rail vehicle.

10. A housing (3, 20) for an air conditioning and/or heating system (1) suitable for enclosing at least one structural element (7, 54) of the air conditioning and/or heating system wherein the housing (3, 20) is designed for rooftop positioning so as to be positioned partially or entirely on the roof of a vehicle (5, 22), made at least partially of a foamed plastic (4), wherein at least one area of the surface of the housing is coated with a material (6) resistant to ultraviolet radiation, and the at least partially of foamed plastic (4) housing (3, 20) comprises at least one part of at least one insert (12, 24, 40) designed so as to contribute to the fixing of the housing (3, 20) on the roof of a vehicle or in a recess on the roof of a vehicle (5, 22).

11. The air conditioning and/or heating system (1) according to claim 1, wherein at least part of the housing (3, 20) further comprises a segment (80) of the housing (3, 20) designed to enclose at least one structural element (7, 54) of the air conditioning and/or heating system (1) suitable for positioning partially or entirely on a vehicle rooftop (15, 20) wherein the segment (80) is made at least partially of foamed plastic (4).
